(19) United States
(12) Patent Application Publication
(10) Pub. No.: US 2014/0306973 A1
(43) Pub. Date: Oct. 16, 2014

(54) METHOD, MODULE AND ELECTRONIC APPARATUS FOR UPDATING CONTENTS TO BE DISPLAYED BEFORE TURNING ON DISPLAY DEVICE

(71) Applicant: MStar Semiconductor, Inc., Hsinchu Hsien (TW)

(72) Inventors: Jhu-Jin Yang, Zhubei City (TW); Chih-Ming Su, Zhubei City (TW)

(73) Assignee: MStar Semiconductor, Inc., Hsinchu Hsien (TW)

(21) Appl. No.: 14/250,456

(22) Filed: Apr. 11, 2014

(30) Foreign Application Priority Data
Apr. 15, 2013 (TW) 102113224

(51) Int. Cl. G06T 1/20

(52) U.S. Cl. CPC G06T 1/20
USPC 345/522

(57) ABSTRACT

A method for updating contents to be displayed before turning on a display device is provided. The method, applicable for an electronic apparatus including a display device, includes steps of: receiving an activation event; and tuning on the display device after the contents to be displayed are updated when the display device is turned off and the activation event is received.

This application claims the benefit of Taiwan application Serial No. 102113224, filed Apr. 15, 2013, the subject matter of which is incorporated herein by reference.

### BACKGROUND OF THE INVENTION

1. Field of the Invention

The invention relates in general to a method for updating a frame of an electronic apparatus, and more particularly to a method for updating contents to be displayed before an electronic apparatus turns on a display device.

2. Description of the Related Art

Energy conservation and carbon reduction are design targets of modern electronic apparatuses. In a modern electronic apparatus equipped with a display device that demands large amounts energy for illumination, a power saving design for a display device is considered as an essential function for all electronic apparatuses. More particularly, for mobile electronic apparatuses operating on batteries, e.g., cell phones and tablet computers, electric energy consumed by a display device is minimized in order to prolong the standby period.

Main approaches for reducing power consumption of a display device are reducing an illumination amount (lowering a brightness level) and deactivation. When an electronic apparatus stays idle for a period of time, the electronic apparatus lowers the illumination amount or brightness level. For example, in liquid crystal display (LCD) devices commonly utilized, the illumination amount of a light-emitting backboard at a rear side of a display device is reduced. When the electronic apparatus stays idle for another period of time in the reduced illumination status, the electronic apparatus turns off the display device, e.g., the light-emitting backboard of the LCD device is completely powered off.

In addition to the two-phase power saving method above, a current electronic apparatus also allows a user to enter a command for entering a power-saving mode. For example, a cell phone is provided with a switch button. When the user presses the switch button, the cell phone immediately turns off the display device and enters a power-saving mode. Alternatively, when a cover of a laptop computer is shut, the display device of the computer automatically shuts down and enters a power-saving mode.

To further save energy utilized by display device, a modern electronic apparatus frequently saves processing capabilities associated with display. For example, after turning off a display device, an electronic loop that controls the output of a display device may also be turned off. Further, an operating system operating on the electronic apparatus may temporarily suspend a program or a process that updates display contents of the display device.

Assume that an electronic apparatus is currently executing a stock price monitoring program. Every minute, the monitoring program connects to a network server that records stock prices to fetch latest stock prices and to update a price column of a display window. A user may then observe the price column to consider stock trading with reference to the updated stock prices.

The execution of the above monitoring program becomes meaningless if a display device is turned off as a user cannot in real-time observe the above price column, and an operating system of an electronic apparatus may altogether turn off the monitoring program. Accordingly, not only the electronic apparatus can save power utilized by the display device, processor resources and network resources consumed by the execution of the monitoring program may also be saved to reinforce power saving effects.

When the above electronic apparatus and display are again turned on, the price column that the user observes on the window still shows older information as before turning off the display device. In certain more sophisticated programs, older information that is not yet updated may be presented by gray font, and an hourglass or a turning timer is shown to remind the user when a cursor is moved within the window. However, for certain programs that are less sophisticated, the older information that is not yet updated may be regarded as new and updated data by the user. Taking the above stock price monitoring program for example, large losses of a user may be caused if the user trades stocks using the older data.

FIG. 1 shows a schematic diagram of a process for updating a frame after an electronic apparatus again turns on a display device in the prior art. In step 110, the display device of the electronic apparatus is turned off. In this step of turning off the display device, the display device may be turned off after the above idle period, or directly turned off by a user command. In step 120, the electronic apparatus receives an activation event. The activation event may be opening up a cover of a laptop computer, or may be triggered by a switch button of a cell phone.

Upon receiving the activation event, the electronic apparatus performs step 130 to turn on the display device and/or associated sub-systems. In the example above, step 140 is performed to have the electronic apparatus update contents to be displayed by the display device, e.g., re-executing the stock price monitoring system and re-connecting to the Internet to obtain the latest stock prices.

As previously described, in the prior in FIG. 1, the user has no way of knowing whether the contents of the display device are updated at first glance on the contents of the display device. The electronic apparatus needs to depend on the various programs to remind the user whether the contents shown in the window are latest information. Therefore, there is a need for an electronic apparatus and a display method that provide a user with updated contents when the display device is again turned on.

### SUMMARY OF THE INVENTION

According to an embodiment of the present invention, an electronic apparatus for updating contents to be displayed before a display device is turned on is provided. The electronic apparatus includes a display device, an input module that receives an activation event, and a processing module. When the display device is turned off and the input module receives the activation event, the processing module turns on the display device after the contents to be displayed are updated.

In another embodiment of the present invention, a processing module that updates contents to be displayed before a display device is turned on is provided. The processing module, applicable to an electornic apparatus including the display device and an input module. When the display device is turned off and the input module receives an activation event, the processing module turns on the display device after the contents to be displayed are updated.

In another embodiment of the present invention, a method for updating contents to be displayed before turning on a display device is provided. The method, applicable to an electronic apparatus including a display device, includes: turning off the display device and stopping updating the contents to be displayed; receiving an activation event; and when the display device is turned off and the activation event is received, turning on the display device after the contents to be displayed are updated.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a process for updating a frame after an electronic apparatus again turns on a display device in the prior art;

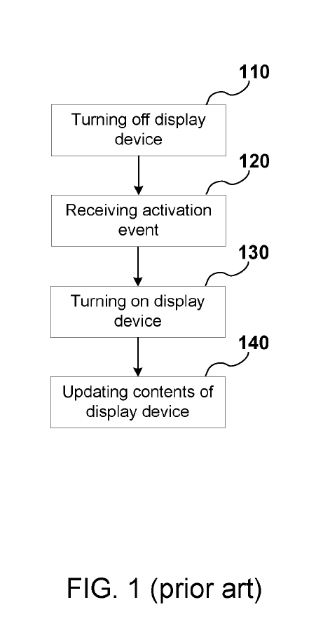

FIG. 2 is a block diagram of an electronic apparatus according to an embodiment of the present invention; and

FIG. 3 is a schematic diagram of a process of a method for updating contents of a display device according to an embodiment of the present invention.

### DETAILED DESCRIPTION OF THE INVENTION

Some embodiments are described in detail below. Apart from the disclosed embodiments, the present invention is also applicable in other embodiments. The scope of the present invention is not be limited by the description of the embodiments, but is to be defined in accordance with the appended claims. To better describe and explain contents of the present invention to one person skilled in the art, different parts in the diagrams are not drawn according to relative sizes or ratios, and certain sizes and associated scales may be enlarged for better distinction. Further, irrelevant details may not be all depicted to maintain simplicity of the diagrams for better understanding.

One feature of the present invention is that, before turning on a display device, contents to be displayed on the display device are updated by an electronic device. Thus, the display device is only turned on after the contents to be displayed are updated to allow a user to observe updated information at a first glance upon the display device.

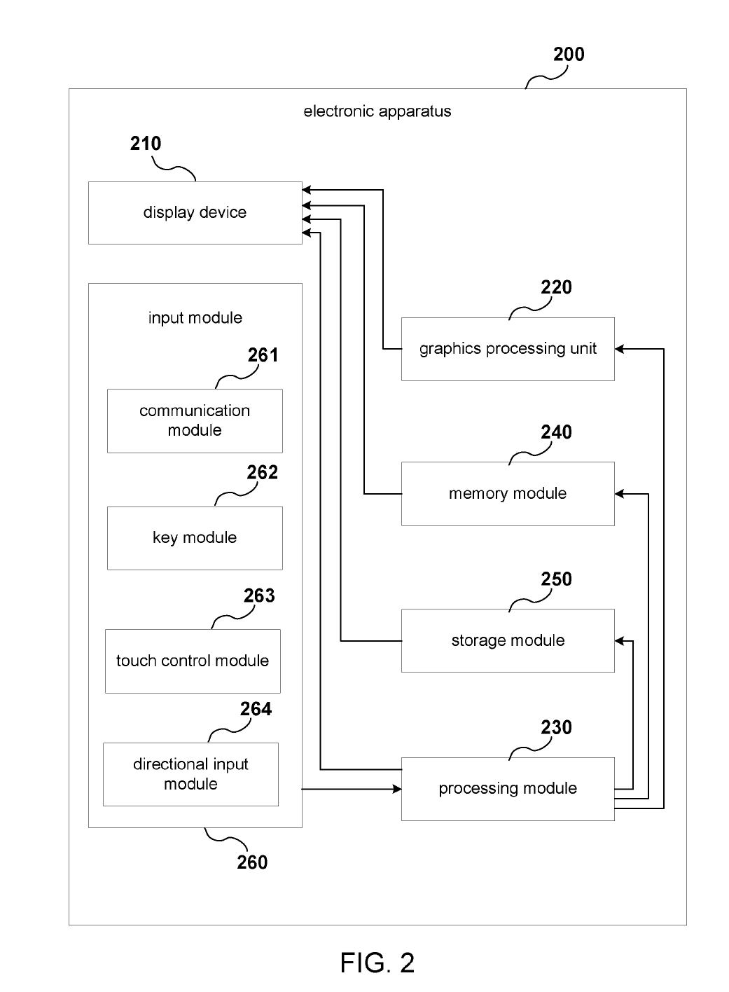

FIG. 2 shows a block diagram of an electronic apparatus 200 according to an embodiment of the present invention. The electronic apparatus 200 includes a display device 210, a graphics processing unit 220 connected to the display device 210, a processing module 230 configured to execute an operating system, a memory module 240 serving as a system memory, a storage module 250, and an input module 260.

For example, the electronic apparatus 200 is a mobile device such as a tablet computer or a cell phone operating on batteries, or a calculation system constantly powered by city electricity. In FIG. 2, the above modules are depicted as separate modules. However, one person skilled in the art can easily understand that the above modules can be integrated with one another. For example, an integrated circuit employed in a modern cell phone may include the processing module 230 and the graphics processing unit 220.

The processing module 230 of the electronic apparatus 200 executes an operating system, and utilizes the memory module 240 as main operation resources. Via the processing module 230, the operating system controls the modules of the electronic apparatus 200, including the graphics processing unit 220, the storage module 250 and the input module 260. One person skilled in the art should easily understand that system programs executed by the operating system or programs executed under the operating system environment can perform the method according to the embodiment of the present invention.

The input module 260 may include one or any combination of several input modules. For example, the input module 260 may include a communication module 261, a key module 262, a touch control module 263, and a directional input module 264. Further, the input module 260 may include other types of input modules such as a global positioning system (GPS) module, a gyroscope module, an inertial navigation module, an accelerometer module, an angular accelerometer module and an optical sensor module. One person skilled in the art can appreciate that there are other input modules 260 that are not mentioned in the present invention, and any input module 260 capable of generating an input event satisfies the description of the embodiment.

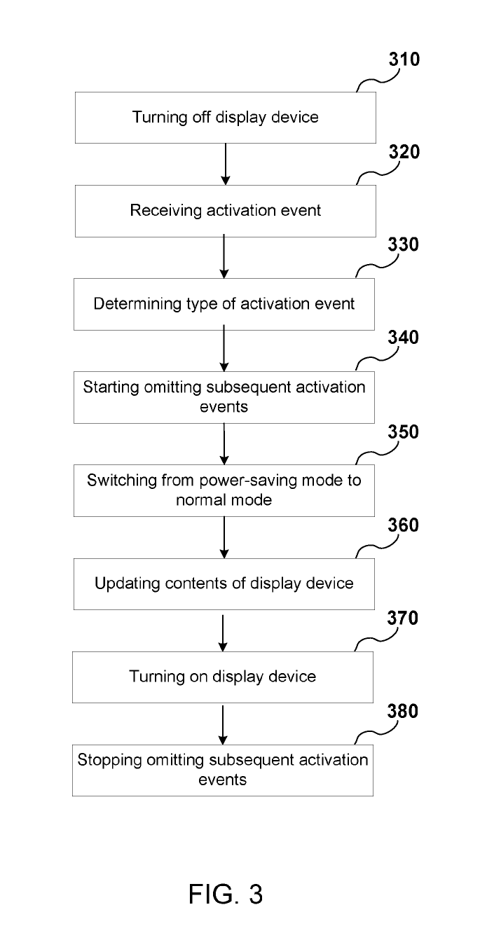

FIG. 3 shows a schematic diagram of a process of a method for updating contents to be displayed on a display device according to an embodiment of the present invention. As previously stated, the method may be performed by a system program executed by the operating system or a program executed under the operating system environment. In step 310, the display device 210 of the electronic apparatus 200 is turned off due to a user-entered command or the electronic apparatus 200 having been idle for a period. In step 320, the input module 260 of the electronic apparatus 200 receives at least one activation event.

One or any combination of the input module 260 in FIG. 2 is capable of sensing an input event, and further utilizing the input event as an activation event for turning on the display device 210. For example, the GPS module and the gyroscope module may inform the processing module 230 of a position of the electronic apparatus 200, and trigger an activation event when a change in the position exceeds a predetermined range. The communication module 261 may be a module that communicates with the outside of the electronic apparatus 200. When the communication module 261 receives a signal of an external network, e.g., receiving a phone call or a short message, an activation event may be triggered. The key module 262 may include any physical or virtual keys, and trigger an activation event when pressed by a user. The touch control module 263 may be a touch surface having more than one dimension, e.g., a writing pad, a touch pad, or a touch screen. Similarly, when receiving a user press or touch, the touch control module 263 may trigger an activation event. The directional input module 264 may be a mouse, a track ball or an optical pen. Upon detecting a change in a cursor position controlled by the directional input module 264, an activation event may be triggered.

Numerous exemplary input events to be utilized as activation events and various input modules that generate the corresponding input events are listed in the above description. Although these activation events may cause the electronic apparatus to turn on the display device 210 and allow a user to observe contents on the display device 210, not all of the activation events have the same properties. The properties of the activation events may include factors such as an urgency of user responses, an information amount corresponding to the activation events, and whether data corresponding to the activation events are readily available.

For example, when the communication module 261 receives an external phone vibration signal, this activation signal means that an immediate user response is required. The information amount corresponding to this phone vibration signal is usually one set of caller number, and this set of caller number is available when the vibration signal is received. Therefore, when such type of activation event in the external phone vibration signal is received, either the method of the prior art or the method according to the embodiment of the present invention may be utilized.

In another example, when the electronic apparatus 200 receives an activation event from the key module 262, it means that a user enters a command to turn on the display device 210. For such type of activation event, the user does not express the urgency for observing contents of the display device 210. Further, the electronic apparatus 200 is unaware of specific information that corresponds to such type of activation event, which means that the user may be interested in any part of the contents of the display device 210. Compared to the single set of caller number, the data amount of contents of the entire display device is much larger. Also assume that before turning off the display device 210 in step 310, a stock price monitoring program is executed under the operating system environment. However, latest stock prices are not stored in the memory module 240 or the storage module 250 of the electronic apparatus 200, and so data corresponding to this activation event is considered unavailable. In this example, as such type of activation event does demand an immediate user response and requires a larger data amount, and the required data is unavailable in the electronic apparatus 200, the method according to the embodiment of the present invention is particularly suitable for such type of activation event.

Therefore, in the process in FIG. 3, an optional step 330 may be performed after step 320 in which the activation event is received. In step 330, the type of the activation event is determined. When the type of activation event can be suitably processed by the present invention, step 340 is performed, or else the process of the prior art is performed. One person skilled in the art can easily understand that three factors for consideration are listed in the description of determining the type of the activation event. However, the determination for the activation event may be performed based on the three above factors, or any combination of the three factors and other factors. In the process in FIG. 3, the determination step 330 may be selectively performed. However, once the activation event is received, subsequent steps are performed.

In an optional step 340 according to an embodiment, activation events subsequently received may be omitted. It is possible that the input module 260 receive more than one activation event. However, only one activation event is required, and computation resources need not be wasted for receiving the subsequent activation events. Further, the subsequent activation events do not interfere with the original process. In an alternative embodiment, step 340 may be omitted. In step 340 according to another embodiment, after receiving one activation event, the input module 260 stops receiving any subsequent activation events. Both of the embodiments save computation resources or power of the input module, and eliminate the interference that the subsequent activation events pose on the process.

After the optional step 340, the process may proceed to another optional step 350. In step 350, the operating system or the associated modules may be switched from a power-saving mode to a normal mode. For example, in the previous example of an incoming call, as the operation of answering the incoming call requires normal operations of the touch control module 263, the touch control module 263 needs to be switched from the power-saving mode to the normal mode. Further, the processing module 230 that controls the electronic apparatus 200 and the operating system also need to be switched from the power-saving mode to the normal mode. Taking the previous stock price monitoring program for example, as the stock price monitoring program requires the communication module 261 to connect to the Internet to obtain the latest program and latest stock prices, the communication module 261 needs to be switched from the power-saving mode to the normal mode. In certain embodiments, the modules that need to be switched from the power-saving mode to the normal mode may include one or any combination of the graphics processing unit 220, the memory module 240, the storage module 250 and the communication module 261. When the above modules are in the power-saving mode and the processing module 230 is to update contents to be displayed, the modules are switched to the normal mode to update the contents to be displayed. However, after turning off the display device in step 310, step 350 may be omitted when the modules of the electronic apparatus 200 are not yet switched to the power-saving mode.

Following the optional step 350 is step 360 for updating the contents of the display device. In certain embodiments, the operating system demands programs that occupy the frame of the display device to update the corresponding parts on the frame. Taking the previous stock price monitoring program for example, the part it occupies on the frame is for displaying latest stock prices, and so the program is requested by the operating system to update the corresponding part on the frame. One person skilled in the art can easily understand that, when the frame of the display device is occupied by many programs, these programs may be requested to update the corresponding contents in the frame. In one embodiment, the updated contents of the frame are updated into the memory module 240, and are transmitted via the graphics processing unit 220 to the display device 210. In an alternative embodiment, the electronic apparatus 200 may not include a dedicated graphics processing unit 220, and may transmit the contents of the frame stored in the memory module 240 to the display device 210 by the processing module 230. In another embodiment, the graphics processing unit 220 is included in the processing module 230. Thus, the contents of the frame stored in the memory module 240 are also transmitted to the display device 210 by the processing module 230.

After the frame of the display device is updated, Step 370 is performed to turn on the display device that then displays the updated frame. As previously stated, in certain embodiments, the graphics processing unit 220 fetches the updated contents of the frame from the memory module 240 and transmits the updated contents of the frame to the display device 210. Accordingly, without needing to consider whether to wait for the electronic apparatus 200 to update the contents, the contents that the user observes at first glance are already the updated contents.

The last optional step 380 corresponds to the optional step 340. Assuming that the optional step 340 is performed, the optional step 380 needs to be performed. In the exemplary embodiment in which the optional step 340 of omitting the subsequent activation events is performed, step 380 renders the operating system of the electronic apparatus 200 to stop omitting the subsequent activation events. In the exemplary embodiment in which the optional step 340 of stop receiving the subsequent activation events is performed, step 380 renders the electronic apparatus 200 to continue receiving the subsequent activation events after turning on the display device. These activation events may trigger other operations different from turning on the display device, or may trigger other types of responses after the display device 210 is turned on.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic apparatus, that updates contents to be displayed on a display device before turning on the display device, comprising:
the display device;
an input module, configured to receive an activation event; and
a processing module, configured to turn on the display device after the contents to be displayed are updated when the input module receives the activation event.

2. The electronic apparatus according to claim 1, wherein the processing module is in a power-saving mode when the display device is turned off, and is switched to a normal mode upon receiving the activation mode.

3. The electronic apparatus according to claim 1, wherein when in the power-saving mode, the processing module stops updating the contents to be displayed.

4. The electronic apparatus according to claim 1, wherein the input module comprises at least one of a key module, a touch control module, a communication module and a directional input module.

5. The electronic apparatus according to claim 1, further comprising a module being in a power-saving mode, the module being at least one of a graphics processing unit, a memory module, a storage module and a communication module; wherein, when the processing module updates the contents to be displayed, the module is switched to a normal mode to update the contents to be displayed.

6. The electronic apparatus according to claim 1, wherein the processing module starts omitting activation events that the input module subsequently receives after the input module receives the activation event, and stops omitting the activation events that the input module subsequently receives after the display device is turned on.

7. The electronic apparatus according to claim 1, wherein the input module stops receiving subsequent activation events after receiving the activation event, and continues receiving the subsequent activation events after the display device is turned on.

8. The electronic apparatus according to claim 1, wherein the processing module determines a type of the activation event after the input module receives the activation event, and turns on the display devices after updating the contents to be displayed according to a determination result and the activation event.

9. A processing module, that updates contents to be displayed on a display device before the display device is turned on, applicable to an electronic device comprising the display device and an input module, the processing module turning on the display device after the contents to be displayed are updated when an activation event is received by the input module.

10. The processing module according to claim 9, being in a power-saving mode when the display device is turned off, and being switched to a normal mode when the activation event is received.

11. The processing module according to claim 9, wherein the electronic apparatus further comprises a module that is in a power-saving mode, and the module is at least one of a graphics processing unit, a memory module, a storage module and a communication module; when the processing module updates the contents to be displayed, the module is switched to a normal mode to update the contents to be displayed.

12. The processing module according to claim 9, starting omitting activation events that the input module subsequently receives after the input module receives the activation event, and stopping omitting the activation events that the input module subsequently receives after the display device is turned on.

13. The processing module according to claim 9, determining a type of the activation event after the input module receives the activation event, and turning on the display devices after updating the contents to be displayed according to a determination result and the activation event.

14. A processing method, for updating contents to be displayed on a display device before the display device is turned on, applicable to an electronic device comprising the display device, the processing method comprising:
turning off the display device and stopping updating the contents to be displayed;
receiving an activation event; and
turning on the display device after the contents to be displayed are updated when the activation event is received.

15. The processing method according to claim 14, further comprising:
when the display device is turned off, rendering the processing module to be in a power-saving mode; and
when the activation event is received, switching the processing module to a normal mode.

16. The processing method according to claim 14, the electronic apparatus further comprising a module that is in a power-saving mode, the method further comprising:
switching the module to a normal mode; and
updating the contents to be displayed by the module in the normal mode;
wherein, the module is at least one of a graphics processing unit, a memory module, a storage module and a communication module.

17. The processing method according to claim 14, further comprising:
starting omitting subsequently received activation events after the activation event is received; and
stopping omitting the subsequently received activation events after the display device is turned on.

18. The processing method according to claim 14, further comprising:
stopping receiving subsequently received activation events after the activation event is received; and
continuing receiving the subsequently received activation events after the display device is turned on.

19. The processing method according to claim 14, further comprising:
determining a type of the activation event after the activation event is received; and
turning on the display device after the contents to be displayed are updated according to a determination result and the activation event.
